(19) United States
(12) Patent Application Publication
(10) Pub. No.: US 2020/0356910 A1
(43) Pub. Date: Nov. 12, 2020

(54) APPARATUS AND METHOD FOR RESTURANT TABLE MANAGEMENT

(71) Applicant: Buzz4it LLC, New Orleans, LA (US)

(72) Inventors: Patrick Nguyen, New Orleans, LA (US); Terrance J. O'Shea, Mission Viejo, CA (US)

(73) Assignee: Buzz4it LLC, New Orleans, LA (US)

(21) Appl. No.: 16/407,107

(22) Filed: May 8, 2019

(51) Int. Cl. G06Q 10/04; G06N 3/08; G06Q 10/06; G06Q 50/12; G06K 19/077; G06K 19/07

(52) U.S. Cl. CPC G06Q 10/04; G06N 3/08; G06K 19/0716; G06Q 50/12; G06K 19/07762; G06Q 10/06316

(57) ABSTRACT

A table management system is described. The table management system includes a host display device for displaying table placements within a room. The host display device includes more than one staff identifier device coupled to staff personnel and more than one table sensor including a communication device. The table management system also includes a server running a table management system algorithm and an aggregator device in communication with the server and in communication with the more than one table sensor. The aggregator device receives presence information and staff information from the more than one table sensor and communicating that information to the server. The server runs a software algorithm for managing table assignments and communicates table assignment information to the host display device.

### BACKGROUND

At conventional restaurants one of the most important problems is that guests and food are not being served in a timely manner which may result in a bad word of mouth leading to negative online reviews and a loss of revenue for the restaurant. This loss of revenue stems from the fact that tables are not being turned over as quickly as possible ergo few customers are served in one day. Also, customers experiencing these problems will not return which may further cause a decrease in future revenues. Further, because of poor service, restaurant Managers may have to issue complimentary food or drinks which leads to a decrease in profit margin.

In conventional restaurants poor service may occur because staff is too busy to wait on guests in a timely manner and staff are often not accountable for slow service. Guests are often frustrated with trying to flag their servers for help. Unfortunately, within conventional restaurants, Managers don't have the right tools to forecast and manage staff. In some instances, tables are taking too long to turn so waiting guests in the lobby may become fed up and leave. This results in a loss of revenue. Generally conventional restaurants use systems which are manual to manage tables and customers and result in an inefficient way to communicate between hostess, server, busboy, and manager.

Accordingly, there is a need for a table and waitstaff management system which enables improved response to customer needs. There is also a need for a system which provides more control for customers to have their needs met. As well, there is a need for a table and waitstaff management system that uses software, and sensors to monitor and determine customer needs and helps to provide table availability information to hostess and dining room staff.

### SUMMARY

An exemplary embodiment relates to a table management system. The table management system includes a host display device for displaying table placements within a room. The host display device includes more than one staff identifier device coupled to staff personnel and more than one table sensor including a communication device. The table management system also includes a server running a table management system algorithm and an aggregator device in communication with the server and in communication with the more than one table sensor. The aggregator device receives presence information and staff information from the more than one table sensor and communicating that information to the server. The server runs a software algorithm for managing table assignments and communicates table assignment information to the host display device.

Another exemplary embodiment relates to a restaurant table management system. The restaurant table management system includes a host display device for displaying table placements within the restaurant and a wait station display device for displaying table placements within the restaurant. The restaurant table management system further includes more than one staff identifier device coupled to staff personnel and more than one table sensor including a communication device. The restaurant table management system further includes a server running a restaurant table management system algorithm. Further still, the restaurant table management system includes an aggregator device in communication with the server and in wireless communication with the more than one table sensor. The aggregator receiving presence information and staff information from the more than one table sensor and communicating that information to the server. The server runs a software algorithm for managing table assignments and communicates table assignment information to the host display device.

Yet another exemplary embodiment relates to a method of managing tables within a restaurant. The method includes providing a host display device for displaying table placements within the restaurant and providing a wait station display device for displaying table placements within the restaurant. The method also includes coupling more than one staff identifier device to staff personnel. The method further includes identifying by more than one table sensor the presence of any customers and the presence of any staff and communicating by the table sensors to an aggregator device over a wireless communication link customer presence information and staff presence information. Further still. the method includes communicating information from the aggregator device to a server running a restaurant table management system algorithm and running a software algorithm by the server for managing table assignments. Yet further still, the method includes communicating table assignment information to the host display device.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an exemplary embodiment of a Table Management System.

FIG. 2 is an exemplary embodiment of a block diagram for a table management system.

FIG. 3 is an exemplary embodiment of the timing and function of sensors and personnel within the table management system.

FIG. 4 is an exemplary embodiment of an under-table sensor mounted to a table.

FIG. 5 is an exemplary embodiment of a block diagram of an exemplary under table sensor module.

The use of the same symbols in different drawings typically indicates similar or identical items unless context dictates otherwise.

### DETAILED DESCRIPTION

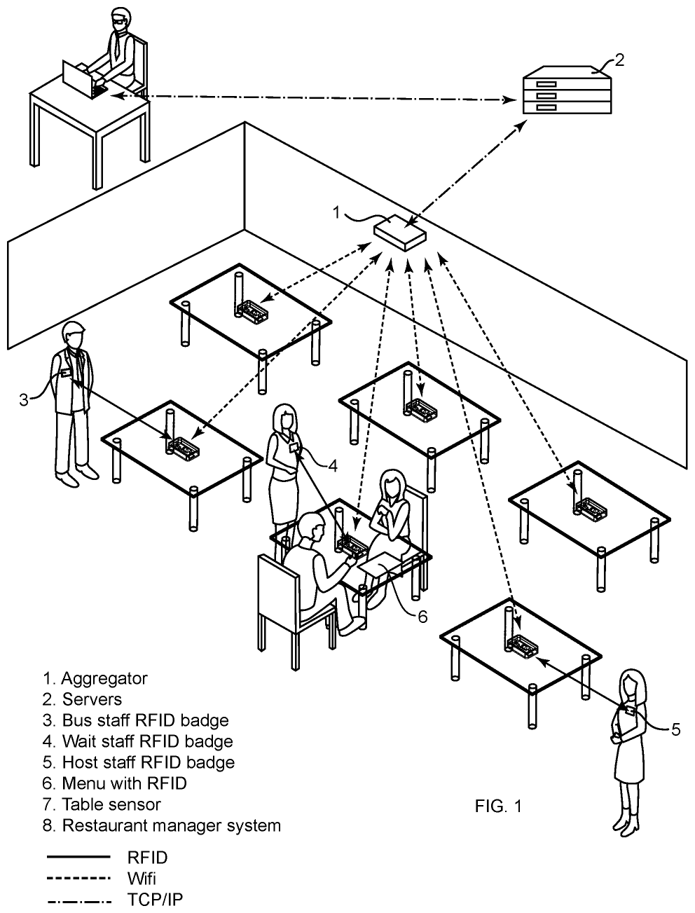

Referring to FIG. 1, an exemplary table management is depicted. The table management system includes a plurality of tables in a restaurant, the table management system uses one or more aggregators 1 which send information to a server 2 running software form the table management system. The server 2 collects information relating to all of the tables in the restaurant. In an exemplary embodiment, staff in the restaurant each staff member wears a Radio Frequency Identification (RFID) badge. RFID badges may include but are not limited to any transceiver portable transmitting an identification message through wireless means (including Bluetooth transceivers and other wireless transceivers). These staff RFID badges include but are not limited to bus staff RFID badge 3, Waitstaff RFID badge 4, and Host staff RFID badge 5. Further, a restaurant menu 6 may also be equipped with an RFID tag.

In accordance with an exemplary embodiment, each of restaurant staff (bus staff, wait staff, host staff, etc.) is equipped with an RFID badge. Each badge at a minimum is coded with a unique class ID according to the staff member's function (e.g., bus, wait, host, etc.). Each restaurant situation is configurable, for example some restaurants may not use a separate host or hostess or in other situations, there may be different levels of servers (food runners versus wait staff, e.g.) or there may be different levels of staff (senior staff versus junior staff versus training staff, e.g.). Each table may be configured with a table sensor 7 that is able to detect the presence of people at the table and further can detect the number of people at each table. Sensors 7 may also include RFID readers such that they can detect what staff is near each table and for how long. Information from each table sensor is communicated over WiFi or the like to aggregator 1 which sends the information over the internet (TCP/IP) or other communication network to server 2.

Server 2 runs algorithms, such as artificial intelligence algorithms (deep learning neural networks and the like) to achieve key performance indicators (KPIs) based on busy times and meals. In an exemplary embodiment there may be more than one aggregator 1 in a restaurant depending on the structure of the building. Each table and table sensor 7 has a unique ID so that the table may be easily identified. The information from the aggregators may be tied into any of a variety of off the shelf or customized table management software systems. In a further exemplary embodiment, information processed by AI engines in server 2 may be provided to administrators or managers in real-time using a restaurant management system 8. Restaurant management system 8 may be used by restaurant managers in real-time to identify problems and make changes to staffing, etc. on the fly or may be used by managers for tracking performance such that longer term changes may be made to staffing, etc. for increased efficiency in the longer term. In accordance with exemplary embodiments all of the electronics used in the table management system may be IP65 rated from the International Electrotechnical Commission (IEC) as published by the International Protection Marking IEC 60529 in accordance with the recommendations of the local restaurant association.

The table management system, as depicted in FIG. 1 includes many advantages over conventional systems in use today. For example, with use of the table management system, restaurant revenue and profits may be increased, which may come from any of the following: (1) Improving the rate of table turning; (2) Increasing customer satisfaction by using a timely device which will decrease comps expenses, decrease negative customer experiences, and decrease negative online reviews; (3) Increasing staff productivity through improved time management; (4) Reducing the number of staff due to increasing productivity and operational efficiencies; (5) Decreasing servers' stress levels due to better time management guidance; (6) Motivating staff with rewards through measurable performance KPI metrics; (7) Helping managers spend less time micromanaging and holding staff accountable for their performance; (8) Alerting the manager as soon as timing issues arise; and (9) Helping manager forecast and evaluating staffing performance to make key decisions. Because of the wearable RFID badges and the table sensors working together, the system is more practical and reduces the issue of false reports and automates the table timing for restaurant users.

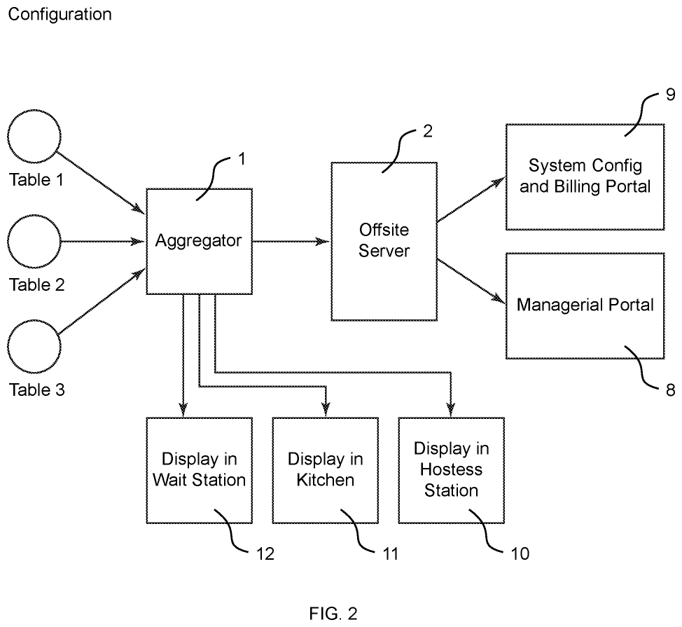

Referring now to FIG. 2, an exemplary block diagram of a table management system is depicted. The table management system includes a plurality of tables outfitted with table sensors which determine when and how many people are seated at a table as well as detecting when staff visits a table. An aggregator 1 receives information from the table sensors and provides the information to an offsite server 2 running the information processing and AI algorithms. This information is processed and is used by kitchen staff (display in kitchen 11), hostess staff (display in hostess station 10), and wait staff (display in wait station 12), to make decisions and perform tasks. Additionally, a managerial port 8 receives information from server 2 in order to monitor the restaurant status in real-time and to make managerial decisions both in real-time and for the longer term.

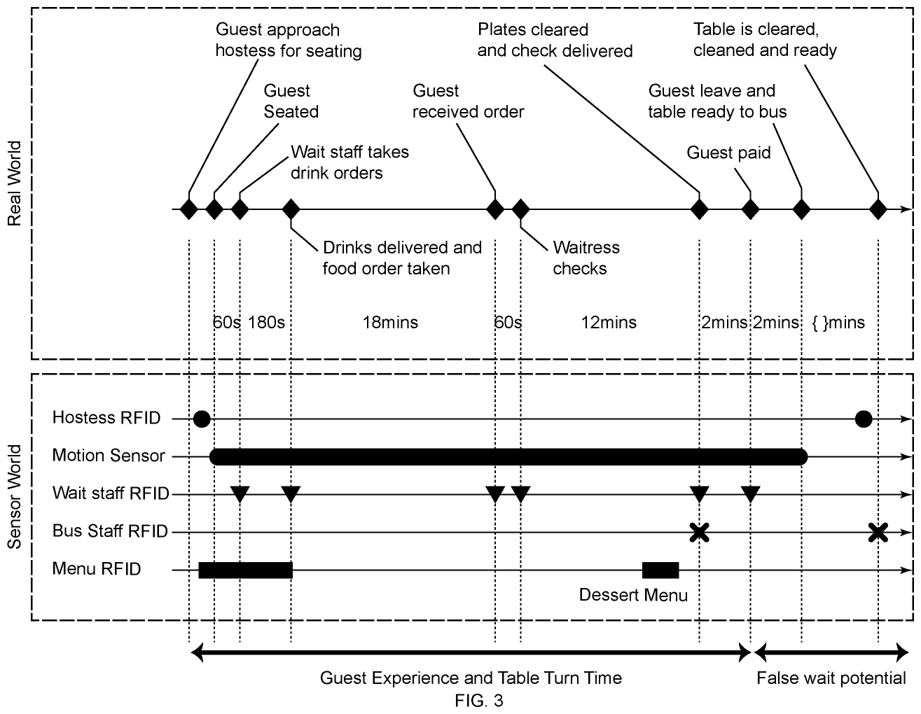

Referring now to FIG. 3, a timeline is depicted showing how the system operates in conjunction with the real world. In the exemplary embodiment shown, guests approach the hostess for seating. The hostess RFID badge identifies that they are at the hostess stand preparing to seat a guest. A sensor at the hostess station can also identify that the hostess picks up the RFID menus. The hostess proceeds to seat the guests at a table where the table sensor identifies the hostess's proximity as well as identifies the number of guests that are being seated at the table and then showing on the hostess display that the table is occupied and by how many people. Next the wait staff visits the table. The RFID reader at the table identifies that the particular wait staff is visiting the table and takes drink orders. As the drink menus are removed from being sensed by the table sensor, the system infers that drink orders have been taken. The waitstaff places the drink orders for the customers and the drinks are prepared. The wait staff then returns to the table to bring the drinks and to take a food order. The wait staff proximity is identified and it is inferred that an order is being taken when the menus are removed from the table. Guests then wait a duration of approximately 18 minutes before the wait staff returns to the table with the food that has been prepared. Once the food is delivered and the guests begin to eat, the wait staff checks back after approximately 60 seconds, each time checking in their proximity to the table is sensed by the table sensor. After the customers have consumed much of their meal, a dessert menu may be delivered and wait staff may bring any dessert ordered. Once the customers are finished eating the wait staff is sensed at the table bringing their check and clearing some dishes by wait staff or alternatively by bus staff. The customers then interact with the wait staff a final time by finishing making payment with them. Once the motion sensors at the table have identified that the customers are gone from the table, then bus staff receives an indication that the table is ready to be cleared completely and readied for a new customer.

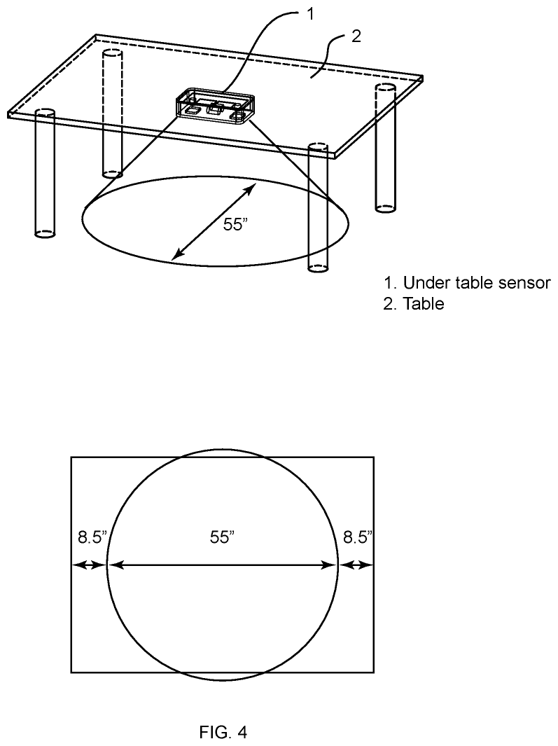

Referring now to FIG. 4, a table is depicted having a table sensor mounted under the table. In a particular exemplary embodiment, the table sensor depicted covers an area as depicted, but is not limited to the area shown. In an exemplary embodiment the sensor module mounted under the table may come in many forms including but not limited to having an RFID reader for detecting the presence of restaurant staff and restaurant objects. The sensor may include any of a variety of technologies for sensing customers (presence sensors) including, but not limited to, infrared (IR) sensors, ultrasonic range sensors, photon counters, light sensors (e.g. photo-electric diodes), proximity sensors (e.g. capacitive sensors), induced eddy current sensors, radio frequency (RF) sensors (e.g., RF doppler sensors), etc.

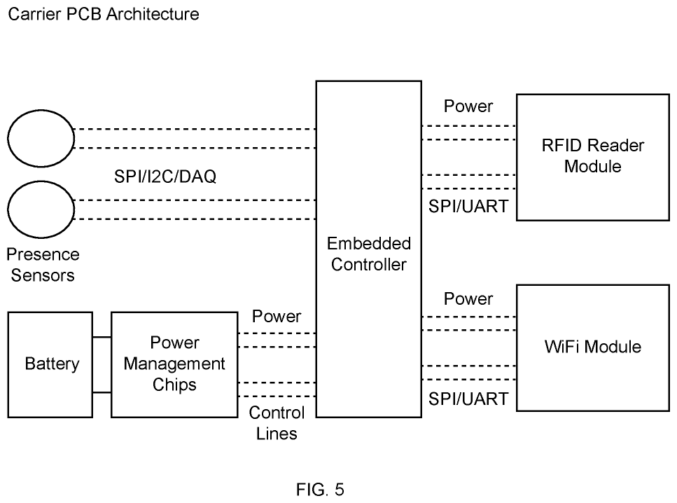

Referring now to FIG. 5, an exemplary block diagram of an under-table sensor module is depicted. The entire module is run by an embedded controller powered by a battery coupled with conventional power management chips. The embedded controller includes software to communicate over WiFi via the on board WiFi module with the aggregator. The sensor module also includes a RFID reader module for sensing the presence of restaurant staff via their RFID badges. The embedded controller is also programmed to communicate with and interpret signals from presence sensors, which as explained with reference to FIG. 4 may be any of a variety of presence sensor without departing from the scope of the invention.

The table management system may also include a feedback system that can be used by both guests and restaurant staff. A button or other triggering device is used to track and guide staff to wait on guest in a timely manner. The button may, e.g., be located under the table and will be use only by the staff Alternatively, the button may be located at the table and used by both staff and guests. Each buzz (press) of the button triggers that a server will get a code yellow warning (visually via display and audibly via a headset) when it is close to the end of an average time period for an event, such as an average time it takes for the guest to look over the menu and be ready to order. Then the server and manager will get a code red alert (visually via display and audibly via a headset) once each time period ends.

For example, in operation a host may seat a table of guests and then press the button. This alert for example will let the wait staff know that the guests are ready for an introduction from a server and possibly to take a drink order. Once the drink order is received, and the wait staff takes the food order from the guests, the button may be pressed by wait staff to send an indication that a food order has been taken. Once the food is ready, the wait staff delivers the food and then returns to take a dessert order after which the button is pressed to indicate where the guests are in the progression of the meal. Next, the server drops off the check and presses the button. The check is then finalized and the server presses the button indicating that bus staff can clean and prep the table for the next customer. The bus staff then presses the button to indicate to host staff that the table is ready for customers. In some embodiments, not only are restaurant staff able to press the button, but the guests are also able to press the button in order to call wait staff. In all cases, having not only a button but also an RFID reader at the table so that the system knows who is pressing the button. In some exemplary embodiments a centralized viewing monitor can be used by a manager to monitor all staff and tables. The manager may have communication with restaurant staff through a radio system.

Time in restaurant studies show that 40 minutes exactly is the optimal time for the highest profits and highest TIPS. The KPI goal for the owner/manager of the restaurant and the employees is how close does each table hit that 40 minute window.

Looking at that each table makes a certain dollar per minute, we know that the highest dollar per minute mark happens at 40 minutes and the highest tips are given at that time. So the KPI's become:
Time the table is empty (customer to customer)
Once seated the optimal time from seating to ordering is one minute. (how close to 1 minute are they).
The next time mark is when food is served. (hopefully way before 35 minutes is up).
The next thing is to have the wait staff deliver the check at the 35 minute mark.
Clearing payment at 38 minutes delivers two minutes to sign the check and leave the tip. (close to 40 min)

Showing the wait staff that the device/system can help them get more tips acts like a carrot making it more fun and a challenge for them. Also they are now rewarded by the customer not by the owner/manager. The owner/manger is optimizing his business, retaining employees (without bonuses) and improving guest experience.

In accordance with further and alternative embodiments, various features may make the system more readily useable for restaurants and restaurant staff. Some of these features include but are not limited to:
1. Being able to show the wait staff the various timed markers for optimal operation.
2. An app or other software for staff phones so that the staff could be called and they could get loyalty app points (another way restaurant owners increase profits).
3. Being able to have set points for when the table is empty and then full again.
4. Enabled customers to return to their favorite table. This could be the utilization of a customer app and the table management system.
5. Return KPI's and forecast back to management to aid in accuracy of inventory.

In development of the software for the aggregator and server Hash tables may include:
Mapping of Sensors Under table to Table Number and Location
Mapping of table number to area of coverage
Mapping of area of coverage to servers/employees on shift
Mapping of Employee name, Job Function (s), Cluster, to RFID tag serial number.
Mapping of Time, Table Number, Occupancy
Mapping of menus to RFID class
Mapping of spare table sensors and space tags per restaurant.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A table management system, comprising:
a host display device for displaying table placements within a room;
more than one staff identifier device coupled to staff personnel;
more than one table sensor including a communication device;
a server running a table management system algorithm; and
an aggregator device in communication with the server and in communication with the more than one table sensor, the aggregator device receiving presence information and staff information from the more than one table sensor and communicating that information to the server,
wherein the server runs a software algorithm for managing able assignments and communicates table assignment information to the host display device.

2. The table management system of claim 1, wherein the staff identifier device may be a RFID device.

3. The table management system of claim 1, wherein the staff identifier device may be a Bluetooth device.

4. The table management system of claim 1, wherein the table sensor may be coupled to the table.

5. The table management system of claim 1, wherein the table sensor may be coupled to the underside of the table.

6. The table management system of claim 1, wherein the table sensor may be one or more remote cameras.

7. The table management system of claim 1, wherein the software includes at least one of artificial intelligence algorithms and neural network algorithms for aiding in table assignments.

8. The table management system of claim 1, wherein the server provides information to a managerial portal.

9. The table management system of claim 1, wherein the server provides information to a system configuration and billing portal.

10. A restaurant table management system, comprising:
a host display device for displaying table placements within the restaurant;
a wait station display device for displaying table placements within the restaurant;
more than one staff identifier device coupled to staff personnel;
more than one table sensor including a communication device;
a server running a restaurant table management system algorithm; and
an aggregator device in communication with the server and in wireless communication with the more than one table sensor, the aggregator receiving presence information and staff information from the more than one table sensor and communicating that information to the server,
wherein the server runs a software algorithm for managing table assignments and communicates table assignment information to the host display device.

11. The table management system of claim 10, wherein staff identifier device may be a RFID device.

12. The table management system of claim 10, wherein the staff identifier device may be a Bluetooth device.

13. The table management system of claim 10, wherein table sensor may be coupled to the table.

14. The table management system of claim 10, wherein table sensor may be one or more remote cameras.

15. The table management system of claim 10, wherein the software includes at least one of artificial intelligence algorithms and neural network algorithms for aiding in table assignments

16. The table management system of claim 10, wherein the server provides information to a managerial portal.

17. The table management system of claim 10, wherein the server provides information to a system configuration and billing portal.

18. A method of managing tables within a restaurant, comprising:
providing a host, display device for displaying table placements within the restaurant;
providing a wait station display device for displaying table placements within the restaurant;
coupling more than one staff identifier device to staff personnel;
identifying by more than one table sensor the presence of any customers and the presence of any staff;
communicating by the table sensors to an aggregator device over a wireless communication link customer presence information and staff presence information;
communicating information from the aggregator device to a server running a restaurant table management system algorithm; and
running a software algorithm by the server for managing table assignments; and
communicating table assignment information to the host display device.

19. The method of claim 18, further comprising:
computing by the software algorithm an optimized use of tables.

20. The method of claim 18, further comprising:
computing by the software algorithm an optimized use of staff.
